(19) United States
(12) Patent Application Publication
(10) Pub. No.: US 2021/0383096 A1
(43) Pub. Date: Dec. 9, 2021

(54) TECHNIQUES FOR TRAINING MACHINE LEARNING

(71) Applicant: BluHaptics, Inc., Seattle, WA (US)

(72) Inventors: Steven James White, Seattle, WA (US); Olof Fredrik Ryden, Seattle, WA (US); Donald Mark Marsh, Bellevue, WA (US)

(21) Appl. No.: 16/895,640

(22) Filed: Jun. 8, 2020

(51) Int. Cl. G06K 9/00; G06K 9/62; G06N 20/00

(52) U.S. Cl. CPC G06K 9/00208; G06N 20/00; G06K 9/6253; G06K 9/00718

(57) ABSTRACT

A system and method are provided for training a machine learning system. In an embodiment, the system generates a three-dimensional model of an environment using a video sequence that includes individual frames taken from a variety of perspectives and environmental conditions. An object in the environment is identified and labeled, in some examples, by an operator, and a three-dimensional model of the object is created. Training data for the machine learning system is created by applying the label to the individual video frames of the video sequence, or by applying a rendering of the three-dimensional model to additional images or video sequences.

### BACKGROUND

Machine learning has experienced explosive growth since some breakthrough work in two areas in the early 2000s including multi-layer neural networks replacing single layer Perceptrons and multi-tree random forests replacing boosted decision trees, resulting in qualitative performance breakthroughs in deep learning and statistical machine learning. While these profound changes have revolutionized machine recognition of speech and images, they are invariably based on large static training sets. Dynamic learning was developed in and promises to extend the technology to handle dynamic learning sets so the robots and their operators can adapt to and exploit new scenarios as they arise in the field.

### BRIEF DESCRIPTION OF THE DRAWINGS

Various techniques will be described with reference to the drawings, in which:

FIG. 1 shows an illustrative example of training and learning operations performed in a machine learning application, in an embodiment;

FIG. 2 shows an illustrative example of output from a Simultaneous Localization and Mapping (“SLAM”) system where range data from a sensor is used to build a 3D model, in an embodiment;

FIG. 3 shows an illustrative example of supervised training, in an embodiment;

FIG. 4 shows an illustrative example of unsupervised training, in an embodiment;

FIG. 5 shows an illustrative example of one-touch supervised training, in an embodiment;

FIG. 6 shows an illustrative example of object location using machine learning and SLAM components, in an embodiment;

FIG. 7 shows an illustrative example of an image that may be analyzed in accordance with various techniques, in an embodiment;

FIG. 8 shows an illustrative example of techniques that can be used to identify connectors from the image data, in an embodiment;

FIG. 9A shows an illustrative example of a simulated object under randomized illumination, in an embodiment;

FIG. 9B shows an illustrative example of an automatically-generated label for the simulated object shown in FIG. 9A, in an embodiment;

FIG. 10A shows an illustrative example of an object overlaid on a real-world background image, in an embodiment;

FIG. 10B shows an illustrative example of a simulated output of the object overlaid on a real-world image, in an embodiment;

FIG. 11 illustrates an example of a process that, as a result of being performed by a computer system, trains a machine learning system to perform object recognition, in an embodiment;

FIG. 12 illustrates a system in which various embodiments can be implemented;

FIG. 13A shows an illustrative example of an environmental model used to identify a 3D model, in an embodiment;

FIG. 13B shows an illustrative example of an environmental model including a 3D model indicative of an object introduced into the environmental model that is to be identified, in an embodiment;

FIG. 13C shows an illustrative example of a difference between an environmental model with and without the 3D model indicative of an object introduced into an environmental model that is to be identified, in an embodiment;

FIG. 13D shows an illustrative example of a 3D model indicative of an introduced object identified in an environmental model, in an embodiment; and

FIG. 14 illustrates an example of a process that, as a result of being performed by a computer system, calculates a difference between a first set of images of an environmental model without an object and a second set of images the environmental model including an object, the difference indicative of the object to be identified by a label, in an embodiment.

### DETAILED DESCRIPTION

The present document describes a system that produces training data for a machine learning system. In an embodiment, the system obtains video of an object within an environment. The object and/or camera are moved relative to one another to capture a variety of images of the object from different angles and under different lighting conditions. A 3-D mapping system is used to generate a 3-D model of the object. An operator identifies the object in the 3-D model, and using this information, the individual images of the source video can be used as training data for a machine learning system. In one example, each frame of the video identifies a bounded region around the identified object, and the image associated with the frame can be tagged and supplied to a machine learning system as training data. Once a 3-D model of the object is obtained, additional tagged training images can be created by rendering the object into existing images, and videos in a variety of orientations, and under different lighting conditions.

Training a machine learning model using simulated data has many advantages. A machine learning model pre-trained on simulated data requires less real-world training data and less time spent training on real-world data to achieve high-performance in new real-world environments compared to an untrained model. By controlling all of the characteristics of a simulated environment, one can generate large amounts of data and its corresponding labels for ML model training without requiring the difficult and time-intensive manual labor that is characteristic of labelling real-world data. Furthermore, new simulated data can be generated rapidly for any new task if the necessary object models, environmental conditions and sensor characteristics are known or available. Training with simulation data can be useful for a wide array of computer vision tasks including, but not limited to, image classification, object detection, image segmentation, and instance segmentation. One challenge associated with the use of simulated data for training a ML model is being able to transfer the model to tasks in the real world with minimal drops in performance. The simulation needs to generate data that, when used to train the ML model, can perform similarly on real-world data or at least improve initial model performance on real-world data compared to an untrained model.

In some examples, to address the challenge of transferring a ML model trained on simulation data to real world data, the system generates simulated data that is sufficiently realistic and variable such that the model can generalize to real-world tasks. This can be achieved by controlling the characteristics of the simulation, such as its environmental conditions, objects of interest, and sensors used to generate data. The simulation can also be setup to generate automatic labels for the data that it generates. This includes labels for whole images used to train an image classification ML model and pixel-wise labels for images to train an image segmentation ML model. Using these tools, one can use simulation to generate large amounts of image data and corresponding labels that can be used to pre-train a ML model before it is trained further with real-world data or directly used for a real-world task. One approach is to detect an introduced object into an environment within a video stream, obtain a label from an operator for a single image of the video stream corresponding to the object, and propagate that label a generated 3D region corresponding to a point cloud indicating a difference between a first set of images of an environment without the object and a second set of images in the video stream including the introduced object in the environment. This approach reduces operator involvement to a “one touch” action of providing the label to images used to train an image classification ML model. A second approach is to include a label with a video stream of an environment including an introduced object and, upon identifying the introduced object, annotating each image of the video stream where the introduced object is visible. This second approach reduces operator involvement to “no touch,” such that an operator validates the label by taking no action.

In some examples, simulated data can utilize 3D CAD models that have dimensions, colors, and textures of real objects. These simulated models can be spawned in different positions and orientations, and under various conditions in the simulated world. For example, a simulated connector can be colored using 3D CAD or graphic design software to look similar to a real-world connector under ambient light. Alternatively, the texture from an image taken of the real-world connector can be directly overlaid on the 3D model of the connector to make its appearance even more realistic. Even material properties such as shiny or translucent surfaces can be controlled in a simulation.

In additional examples, the environmental conditions of the simulated world can be varied. In various embodiments, variable light sources, color and amounts of illumination, shadows, presence of and occlusion by other objects can be applied. Furthermore, sensors can be simulated that record data in this environment are responsive to changes in these environmental conditions. This can range from simple grayscale cameras to LIDARS and sensors such as a Kinect sensor which records both RGB images as well as 3D depth data. These sensors can be simulated to have similar characteristics to real-world sensors. This includes, among other things, the sensor's field of view, resolution, RGB image noise, and error in depth measurements. By controlling these characteristics, the goal is to make the data generated by the simulated sensors realistic and variable enough to train a ML model in a way that improves performance in a real-world environment.

Techniques described and suggested in the present disclosure improve the field of computing, especially the field of machine learning, and especially machine learning involving operator manipulation of real-world physical objects by providing techniques that improve computing efficiency and that improve the results obtained using typical approaches.

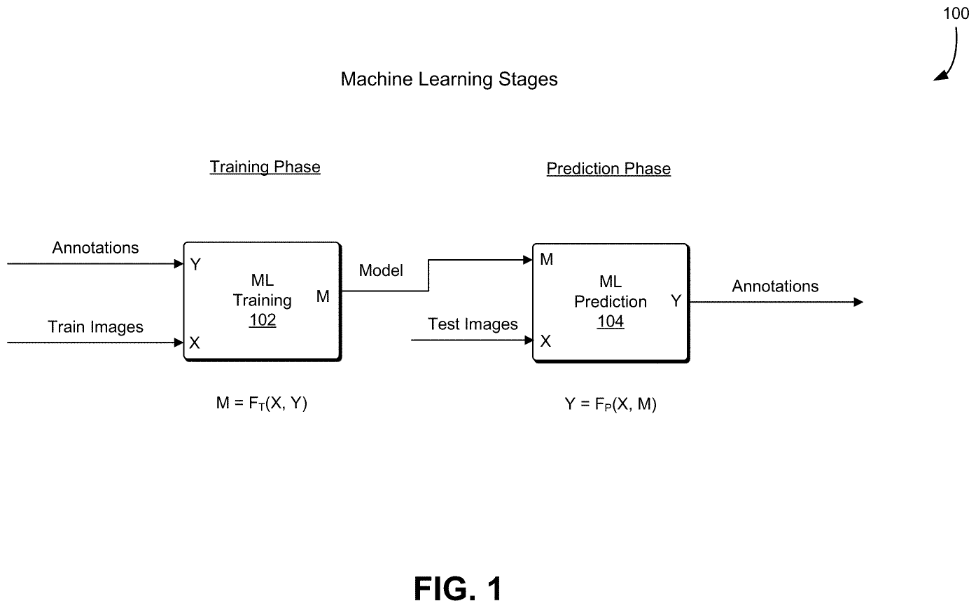

FIG. 1 shows an illustrative example of training and learning operations 100 performed in a machine learning application, in an embodiment. In many examples, there are two operational phases involved in machine learning applications: training phase operations 102 and prediction phase operations 104. The training phase 102 takes images (X) and labels (Y) for those images (e.g. ‘connector’, ‘cable’, etc.) and produces a model (M) which is passed to the prediction module. The prediction phase 104, in turn, takes that model (M) and new image data (X) and produces labels (Y) for that data.

In an embodiment, SLAM is a family of algorithms that take sensor data and, in sequence, map that data to a 3D (or greater dimensional) model that is iteratively updated. That mapping informs the system how the sensor has moved relative to the world model in the moment of capture and thus can track the sensor and, if the sensor location is known relative to a robot, can track the robot in embodiments where a pilot controls a robot to perform the work, although embodiments that use autonomous or semi-autonomous robots are also considered as being within the scope of the present disclosure. As a byproduct, an iteratively refined high-fidelity world model is produced along with the real-time tracking capability.

Improved high fidelity and robust 3D model and motion tracking are achieved using dense 3D sensor data. In some examples, sensors of the Kinect family of sensors are used for these purposes and are preferred. The Kinect family of sensors rely on either structured light or time-of-flight sensors to produce full-frame color and depth (“RBGD”) data at frame rates of 30 fps or more. In some examples, stereo or even monocular video sensors are used that greatly broaden the application domains of these algorithms.

In some embodiments, to generate a high-fidelity model, the sensor moves. A stationary sensor will generally produce a single unique view unless the subject is moved relative to the sensor. By moving the sensor, it is possible to build a more complete model of the scene that encompasses many poses of components likely to be encountered when performing tasks after training. As such, in many embodiments, the sensors move about and capture a range of poses during model construction.

In some embodiments of the training phase 102, a SLAM algorithm generates a first textured 3D map of the workspace, such as by a moving imaging device capturing a video stream of the workspace, that defines an environmental model. One or more objects are then introduced into the workspace and an additional SLAM algorithm generates a second textured 3D map of the workspace including the introduced objects. As the 3D map is generated, key-frame images and their associated estimated camera positions can be saved. These key-frames can correspond to different views of the workspace and can be registered to the 3D map. The saved key-frames can be displayed in an application user-interface.

A point cloud can be generated for each introduced object based on the difference between the environmental without the introduced object and the environmental model with the introduced object, and the points of the point cloud are recorded for the corresponding image(s) each point was derived from. Processing the difference can include comparing pixels of key-frames of the environmental model without the introduced object and pixels of key-frames of the environmental model with the introduced object. The point cloud can be used to a render a 3D model of the introduced object.

Once mapping is complete, a 3D label corresponding to the introduced object can be obtained, such as from an operator, and the 3D label positioned in a 3D rendering of the workspace. The 3D label can correspond to all of the key-frames collected during mapping. The 3D label can include a bounding region superimposed over a display of the introduced object and text indicative of the introduced object. In other words, a label corresponding to the point cloud representative of the introduced object can be applied to those pixels representative of the introduced object in each frame of a video stream. The saved key frame labels and associated images can be used as annotations and corresponding training images to train a ML model.

In some embodiments of the prediction phase 104, a workspace including an object similar to the introduced object is obtained by a SLAM algorithm generating a textured 3D map of the workspace. Based on the saved key-frames, the similar object can be predicted to have the same label as the introduced object, regardless of the position and/or orientation of the similar object relative to the workspace.

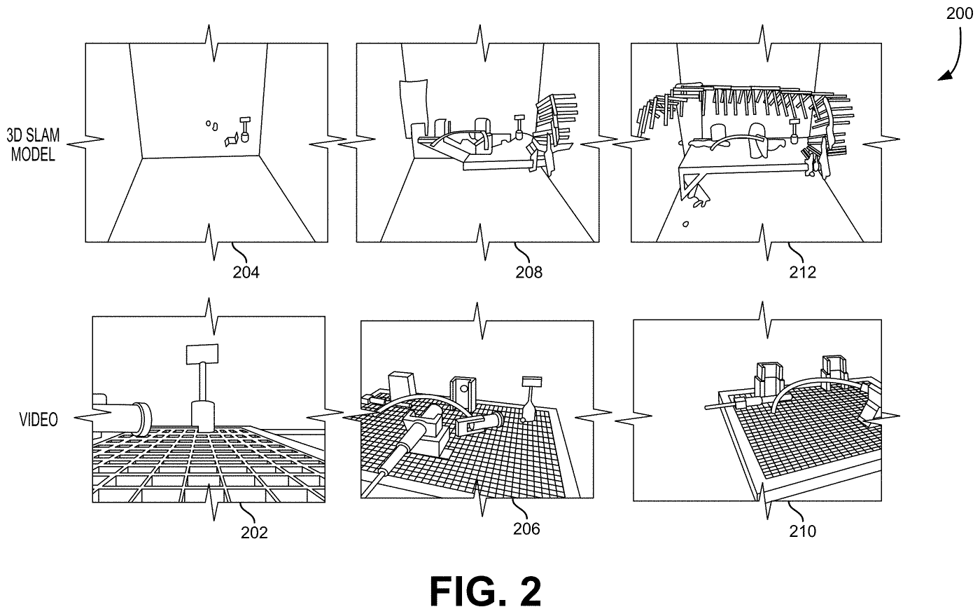

FIG. 2 shows an illustrative example of output from a Simultaneous Localization and Mapping (“SLAM”) system where range data from a sensor is used to build a 3D model, in an embodiment. FIG. 2 illustrates a demonstration 200 of simultaneous localization and mapping (“SLAM”) where range data from an Asus Xtion sensor is used to build a 3D model of a table and equipment in a laboratory. Corresponding video from the sensor is also shown. In various embodiments, textures are added and a stereo camera is used. In the example illustrated in FIG. 2, a first image 202, is processed by the SLAM system to produce a first 3-D model 204, a second image 206 is processed by the SLAM system to produce a second 3-D model 208, and a third image 210 is processed by the SLAM system to produce a third 3-D model 212.

Machine learning algorithms are useful in identifying objects that the robot will need to interact with or avoid. Once an object and its surroundings can be localized in 3-D space relative to the sensors and the rest of the robot, the Control Software has the information it needs to guide the pilot and/or robot (e.g., in embodiments utilizing autonomous control of the robot) to perform the intended tasks using virtual fixtures. To localize these objects, in an embodiment, the first step is to have the system be able to recognize important objects to interact with as well as the surrounding material which should be considered when planning any tasks. For instance, when the task is to connect two cable connectors, the respective connectors are targets that are grasped. The cables and other surrounding structure are also accounted for to insure collision-free mating.

Just as there are many excellent algorithms for SLAM, there are as well many algorithms that excel at identifying things—generally referred to as machine learning. Like SLAM too, they generally each have domains where each excels. Accordingly, different algorithms are selected for different use cases. One of the best known, deep learning, stands out for its overall performance and accuracy when supplied very large training datasets and is favored in situations where that is possible—which is often the case. In cases where it is important to distinguish a cat from a car—such as in autonomous vehicle application domains—deep neural nets are frequently favored. Another technology that is often used either with neural nets or as a standalone classifier is Decision Forests. One of appealing characteristics of Decision Forests is that with small data sets (mere hundreds or thousands of training images, for example) they out-perform deep neural nets in both speed and accuracy; they come up to speed faster. This trait makes decision forests favorable for the machine learning step in many embodiments where in-situ training is needed, although other techniques may be used.

In a typical embodiment, there are two steps included in the machine learning application: training and prediction. These are shown in FIG. 1. The training phase takes images (X) and labels (Y) for those images (e.g. ‘connector’, ‘cable’, etc.) and produces a model (M) which is passed to the prediction module. The prediction phase, in turn, takes that model (M) and new image data (X) and produces labels (Y) for that data.

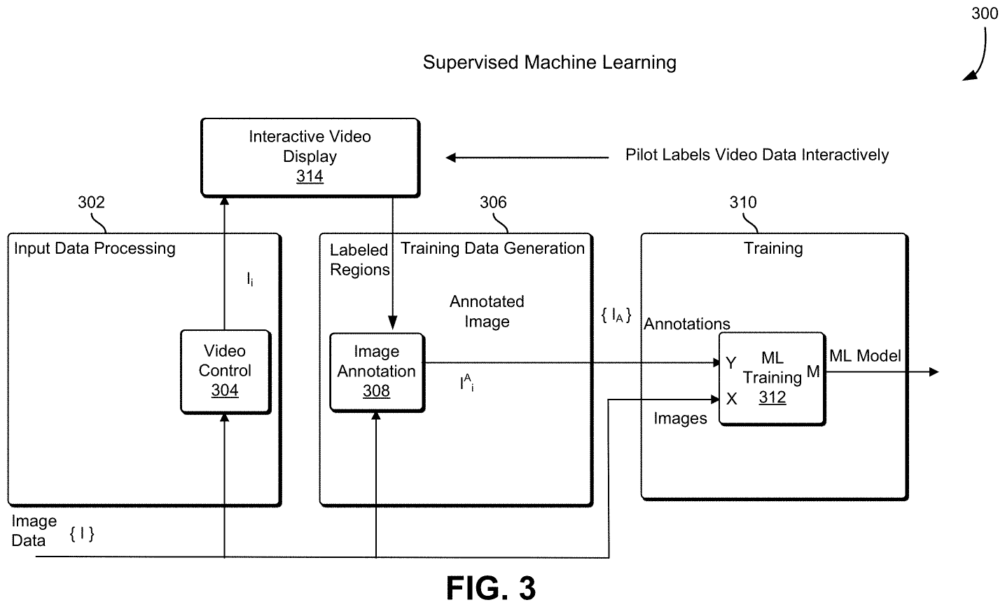

FIG. 3 shows an illustrative example of supervised training 300, in an embodiment. In some examples, supervised, unsupervised, and minimally-supervised (‘one-touch’) machine learning is used. In supervised training 300 the pilot uses a special annotation application to provide the training annotation data (Y) for the sensor data (X) to get the training model (M).

In an embodiment, image data is collected from one or more image sensors. In various examples, image sensors may include video cameras, infrared video cameras, radar imaging sensors, and laser infrared distance and ranging (“LIDAR”) sensors. The image data is provided to an input data processing system 302 that provides video control 304, a training data generation system 306, and a training system 310. The input data processing system 302 provides the image data to an interactive video display 314. A pilot to use the image data, and using the interactive video display 314, provides labels for various objects represented in the image data to the training data generation system 306. An image annotation subsystem 308 links the labels provided by the pilot to the image data corresponding to objects, as distinguished from not objects, and provides the annotations to the training system 310.

In some implementations, labels are provided to the training system 310 in the form of a label, a video frame identifier, and a closed outline indicating the bounds of the labeled object. The annotations and the images are provided to a machine learning training subsystem 312 in the training system 310. The machine learning training subsystem 312 uses the labels and the image data to produce a machine learning model.

Machine learning is adept at identifying objects given adequate training data and proper curation of the data fed to the algorithm during training. In some examples, the ‘curation’ step—the collection and annotation of images with relevant tags—is a manual and labor intensive step. In some examples, collection and annotation of images can be very time consuming and is generally not considered ‘interactive’ or ‘real time’. This approach is called supervised machine learning. While laborious, the training of machine learning using hand-generated annotations of images is a commonly used approach, and its utility often heavily depends on the editing and workflow tools used for creating such annotations.

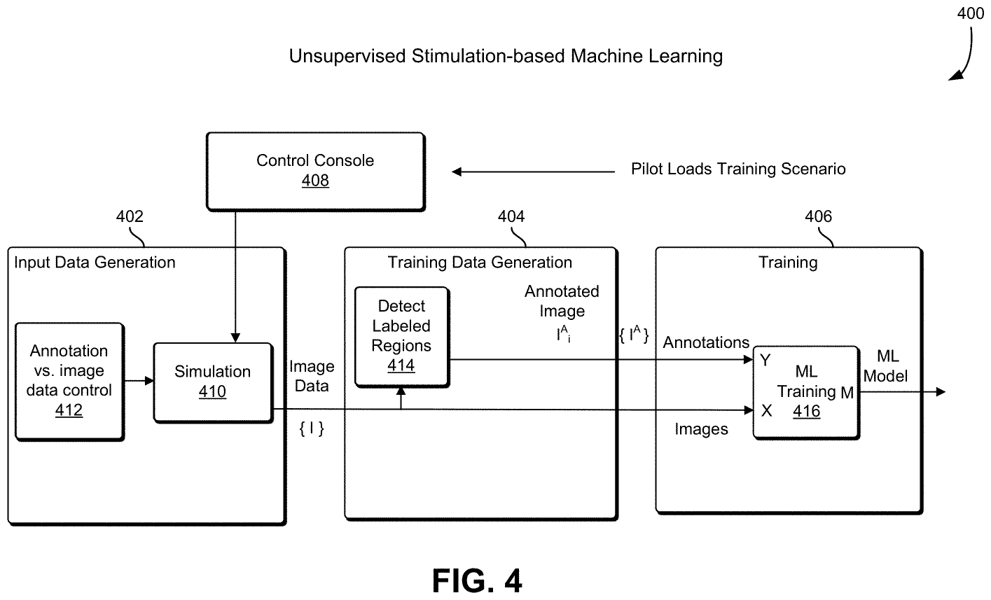

FIG. 4 shows an illustrative example of unsupervised training 400, in an embodiment. In unsupervised training 400, a realistic simulation program simplifies the training data generation problem to make the training effectively unsupervised. In one example, a pilot loads a training scenario using a control console 408. In various embodiments, the control console 408 is a computer system such as a personal computer system, laptop computer system, or handheld computer system that includes a user interface. The user interface can include a display screen, keyboard, mouse, trackpad, touch screen, or other interface that allows the pilot to specify the training scenario. The training scenarios provided by the control console 408 to an input data generation system 402.

In an embodiment, the input data generation system 402, in various examples, inputs the training scenario into a simulation subsystem 410. The simulation subsystem 410 establishes a mathematical model of an environment based at least in part on the training scenario. The input data generation system 402 includes an annotation and image data control subsystem 412 that, in combination with a simulation subsystem 410, produces image data which is provided to a training data generation system 404.

In an embodiment, the training data generation system 404 acquires the image data from the input data generation system 402. The region detection subsystem 414 analyzes the image data and identifies regions of the image that are associated with various labels and provides the annotated image to the training system 406.

The training system 406 receives the images and the annotations at a machine learning training subsystem 416. The machine language training subsystem 416 uses the annotations on the images to produce a machine learning model.

In an embodiment, the system trains the machine without image and detailed annotations and the system generates its own annotated training data. In some implementations, training data, such as annotated images from a video sequence, is obtained in an automated way is to produce accurate simulations of the environment for the task involved and extract both image and annotation data from the simulation. In many cases the number of environmental variables such as the medium, illumination, albedo, and geometry collectively conspire to make such a simulation fall short of the quality desired, but in an environment like those in space, many of these variables are highly stable and predictable.

In some examples, a one-touch/Simulated machine learning system is used to generate the training data. In one example of a one-touch machine learning system, the system is based on SLAM, and the system provides a large amount of data to the machine learning model for training. Various implementations use the SLAM model to generate the training data. For example, the SLAM system may obtain video of a connector being waived around, and use that video to create a 3D point cloud of the connector. The connector is then identified and labeled. For example, the system can generate a 3D point cloud representative of the connector and records the points in corresponding image(s) of the video from which each point is derived from. Then the system uses the recorded points to label which pixels in the corresponding frames of the video are the connector. Using the images collected by SLAM, the label can be applied to many of the 2-D frames captured resulting in training data for the machine learning system. By using SLAM to produce a point cloud for an object in this way, training data is produced as a byproduct.

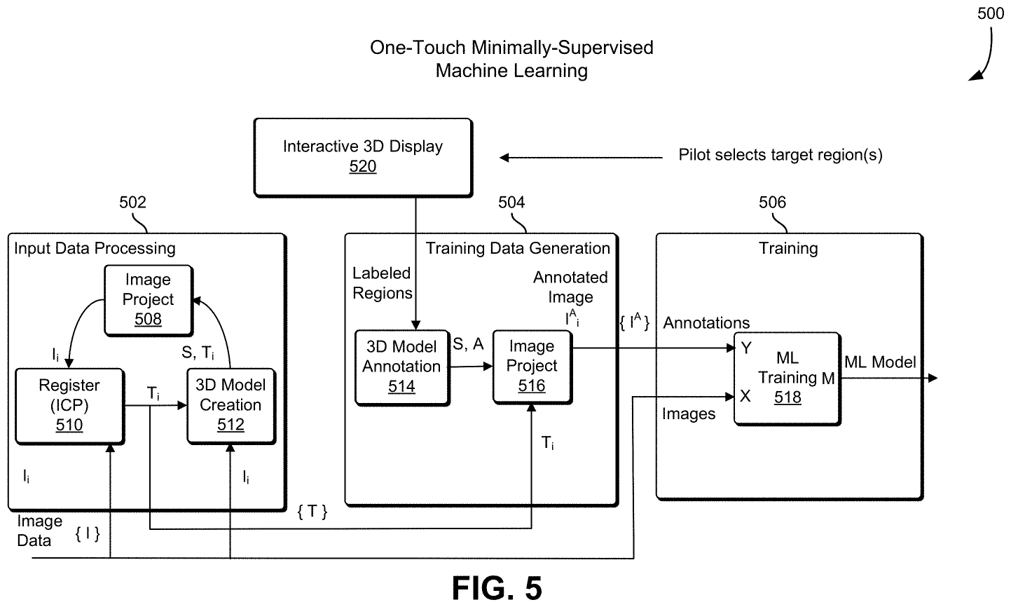

FIG. 5 shows an illustrative example of one-touch supervised training 500, in an embodiment. In an embodiment, a system includes an input data processing system 502, a training data generation system 504, and a training system 506. In one example of one-touch supervised training, input data produces a 3-D scene model allowing the operator to label all relevant data collected with a minimum of effort. An embodiment named “one touch” or “minimally-supervised” machine learning uses the data fusion power of SLAM to create a single 3-D model of the scene in front of the robot and allow the operator to, with minimal interaction—the proverbial ‘one touch’—inform the system what regions of the models are targets (e.g. connectors) and what are not (e.g. cables). With that minimal information, the system itself can generate the volumes of training data needed for the machine learning step and produce a model that can recognize reliably the objects in subsequent actions.

In an embodiment, image data is captured using an image sensor such as a video camera, radar imager, or LIDAR imager. The image data is provided to an input data processing system 502. The input data processing system 502 includes a 3-D model creation subsystem 512, and image projection subsystem 508, and a register ICP subsystem 510. In one implementation, the register ICP subsystem 510 is a SLAM subsystem. Image data is provided to the 3-D model creation subsystem 512 which creates the 3-D model of the image environment. The model is provided to the image projection subsystem 508 which generates an image from the 3-D model and provides it to the register ICP subsystem 510. The register ICP subsystem 510 generates training images which are sent to the training data generation system 504.

The training images are received at the training data generation system 504 by an image projection subsystem 516. In some embodiments, a pilot or operator uses an interactive display 520 to select and apply a label to a portion of a 3-D model. In some examples, the operator is presented with an isometric view of a three-dimensional model and outlines a portion of the model with a mouse, touchscreen, or touchpad to identify a three-dimensional object. The user may be prompted with a text input dialog or a list of possible labels that can be applied to the outlined region indicative of the object. For example, the operator can be prompted to label connectors or wires on a three-dimensional model of the circuit board. Information identifying the labeled regions is provided to the training data generation system 504. The information identifying the labeled regions is provided to a 3-D model annotation subsystem 514 in the training data generation system 504. The 3-D model annotation subsystem 514 provides the annotation information to the image projection subsystem 516 which provides annotations to the training system 506.

The training system 506 receives the annotations and the images from the original image data, and provides the annotations and images to a machine learning training subsystem 518. The machine learning subsystem 518 uses the annotations and the images to produce a machine learning model.

The nature of the pilot interaction can be implemented in a variety of ways. In some examples, approaches can be to place a ‘cut plane’ on the model to segregate model regions, or ‘paint’ on the model and use region-morphological algorithms to segment the model. Using such techniques, a result is that that interaction is made less burdensome and in many examples takes only a few seconds to complete a single labeling that will ultimately produce a stream of training examples it would take hours to create by hand.

In one embodiment, as the model is annotated with these labeled segmentations, a training data is generated by ‘reversing’ the SLAM data fusion step and re-mapping the labeled regions back to the original set of input data images. For example, in every image where a region was labeled ‘connector’ is visible in a capture frame, an annotation file may be produced indicating the points in the image so labeled as differentiated from the connector environment or other objects—in effect producing the data now manually produced by human trainers of supervised machine learning systems. Not every frame of data capture is needed from the original input data, but a rich set of hundreds of frames of original data and their associated annotations will be produced and passed on to the machine learning stage for training.

Once the SLAM data model has been reverse-engineered into matching image/annotation datasets, in an embodiment, these are fed into the decision forest algorithm to train up the machine learning model (a series of decision trees that each vote on each image as to how to label the pixels). Once the training is complete—often in a matter of seconds—the system is ready to become operational: it can recognize and locate objects like connectors and cables and help the pilot perform their tasks and/or aid autonomous or semi-autonomous control of the robot to perform the tasks.

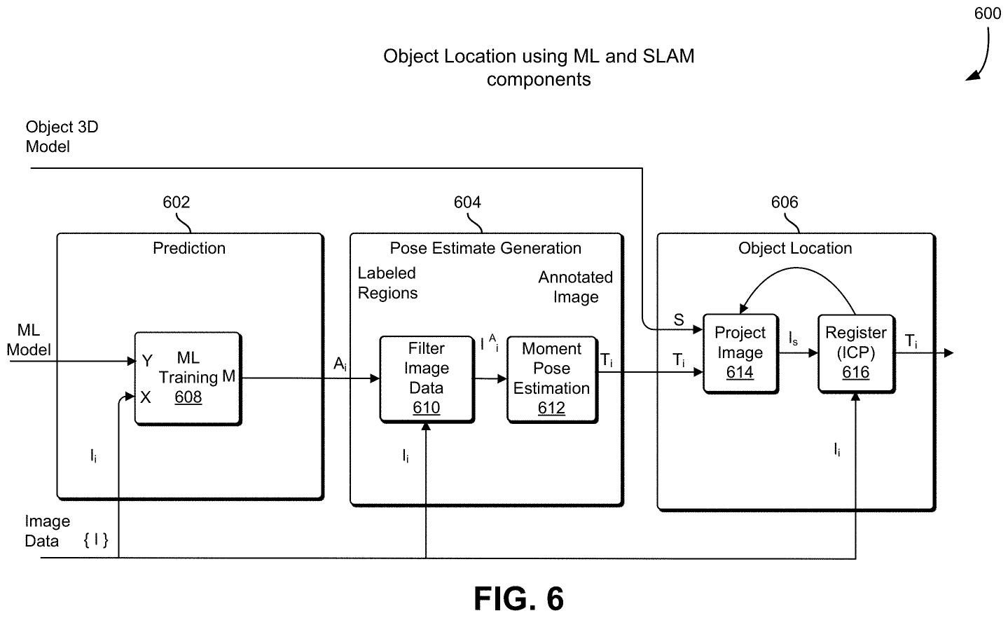

FIG. 6 shows an illustrative example of a system 600 that provides object location using machine learning and SLAM components, in an embodiment. FIG. 6 illustrates object location using machine learning and SLAM components. In various examples, this phase is comprised of three stages: 1) an ML prediction phase performed by a prediction system 602, 2) a post-processing stage that finds an initial pose estimation from the segmented labeled clusters performed by a pose estimate generation system 604 and 3) a SLAM/ICP model-based pose refinement phase performed by an object location system 606 that produces a final 6-degrees-of-freedom pose for each identified object.

Once trained, in an embodiment, the system is now able to identify objects and where they are in the environment around the robot. For example, for critical guidance and grasping operations, the system 600 will use the machine learning to label the images of the objects which can be precisely localized in six-degrees-of-freedom, although different degrees of freedom may be used in various embodiments. These localizations are used to set virtual fixtures to guide the pilot and/or to guide the robot, such as in embodiments where robot guidance is autonomous or semi-autonomous. As the robot/sensors move, in various examples, the data is updated in real time.

In one example, the machine learning model and image data is provided to the prediction system 602. A machine learning training subsystem 608 of the prediction system 602 uses the image data and the machine learning model to label one or more objects present in the image. The label information and the image data is provided to the pose estimate generation system 604 which filters the image data 610 and then estimates 612 the orientation or pose of the object in the image. In some examples, the pose estimate generation system 604 generates a six-degree-of-freedom pose estimate for the object. The pose estimate generation system 604 provides the pose estimation to the object location system 606. Using the 3-D object model, the pose estimation, and the image data, the object location system 606 generates location information for the object using in image projection subsystem 614 and a register ICP subsystem 616.

One advantage attained by the embodiments disclosed herein is that the processing steps for this process are much the same regardless of the training technique. In an embodiment, the first step in the process is to have the machine learning use the model from the earlier training phase and the incoming real-time sensor data to label where in the scene the objects of interest are by labeling the image data points. For example, a 3D point cloud representing an objects can be labeled, where the 3D point cloud distinguishes the region of the image data points indicative of the object from the region of the image data points indicative of not the object. The second step takes these labeled points and segments them into separate sets. Each such filtered set for a given object is run through a filter to extract moment information that establishes an initial six-degree-of-freedom (“DOF”) pose estimate for that object. This estimate seeds the same process from SLAM used for model generation, except it now is used to refine the six DOF estimate, in some embodiments exclusively. The model data S can vary depending largely on what is available at train time: if a computer aided design (“CAD”) model of the located object is available we can use that, if the segmented SLAM 3-D model is available, we, in turn, use that. If no model is available—usually the case when supervised, and largely manual, training was used to create the train model, we can often rely on the initial moment-based pose-estimation as our final result. In many cases, this is adequate for the task.

While at first glance these training approaches may seem disconnected, they are, in fact, part of a coherent training strategy that not only gets applied in the same software framework, but are each often useful in the same scenarios:
Simulation-based unsupervised machine learning is particularly useful when the ultimate in precision is needed or desired and cad-style object models are readily available.
One-Touch minimally supervised machine learning (and its constituent SLAM model) is particularly useful when CAD models are not readily available or practical (e.g. the world model which is hugely important for guidance).
Supervised machine learning, in turn, is particularly useful when there are no models or the models don't apply—especially when things change dynamically (twisting cables, for example). The machine can still locate them and assign fixtures to them with minimal manual (but still not model-based) training.

In various examples, training data can be generated using the labeled 3-D models by rendering the 3-D-models in combination with existing images, backgrounds, and simulations. The objects can be rendered in various positions and orientations, and with various lighting, textures, colors, and reflectivity. For example, stock background footage can be combined with a rendered object constructed from a labeled 3-D model. This allows the system to identify and label the rendered object, allowing the resulting image to be provided to machine learning system as training data. In one example, a 3-D model of an object can be added as an object in a moving video, thereby allowing each frame of the moving video to be labeled and used as training data.

In one embodiment, the workflow for the interactive machine learning approach, is as follows:
1. Before deployment in remote environment, the machine learning system is primed with a priori simulations of tasks and environments. This can, for instance, include CAD models, dynamic simulations, or even virtual fixture/affordance templates. As an example, the latter may inform the algorithm that “knob” is often seen near “lever” and thus increase confidence in both labels.
2. Once the robot is deployed the machine learning detects known objects. It should be noted that the sensor data in combination with the simulation information can be used to robustly classify even partially-obstructed objects.
3. During operation if/when false positives/negatives occur, the operator makes corrections and the machine learning re-trains at frame-rate. This allows the operator to make simple corrections, check output and re-iterate as needed rather than spend excessive time labeling redundant information.

By implementing a more robust machine learning algorithm that can be retrained in real-time, sufficiently good output from the algorithm is obtained such that that the six-DOF regression problem also can be solved robustly. This software will thereby bridge the gap between traditional virtual fixtures (that only have been used in static or very simple environments) and real-world operations.

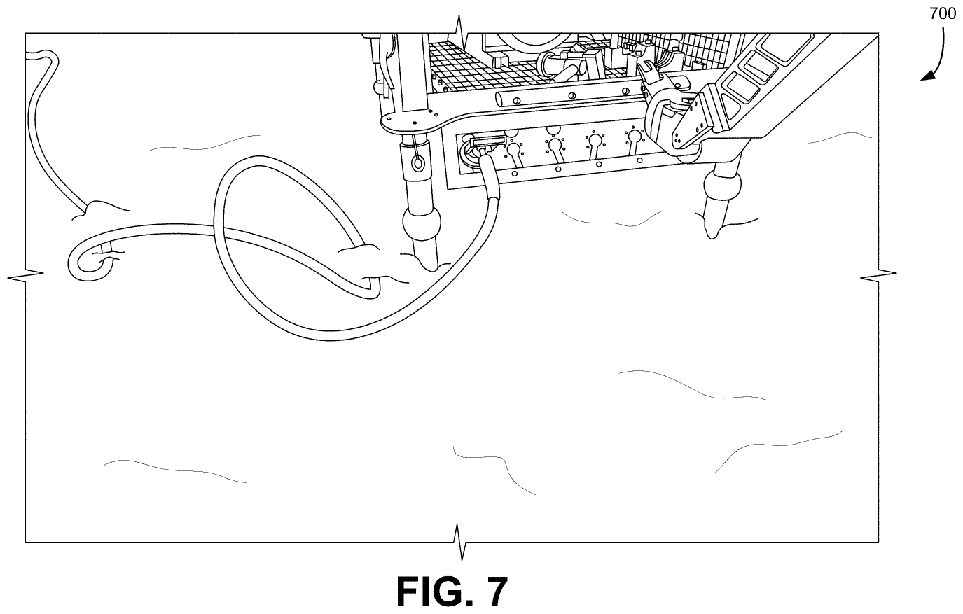

FIG. 7 shows an illustrative example of an image 700 that may be analyzed in accordance with various techniques, in an embodiment. The following is a sample image that may be analyzed in accordance with various techniques discussed herein. As shown, the image shows equipment with connectors and a robotic arm that manipulates the connectors for connection of components to the machinery.

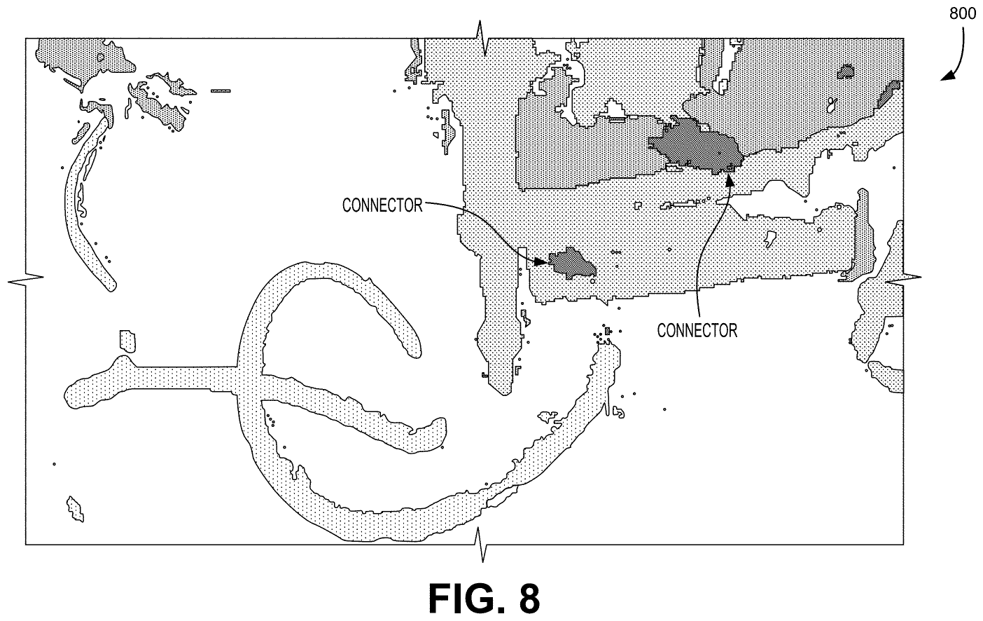

FIG. 8 shows an illustrative example of an image 800 of techniques that can be used to identify connectors from the image data, in an embodiment. The following demonstrates results of the use of techniques described herein after analyzing the above image. As can be seen, techniques of the present disclosure are able to identify connectors from the image data:

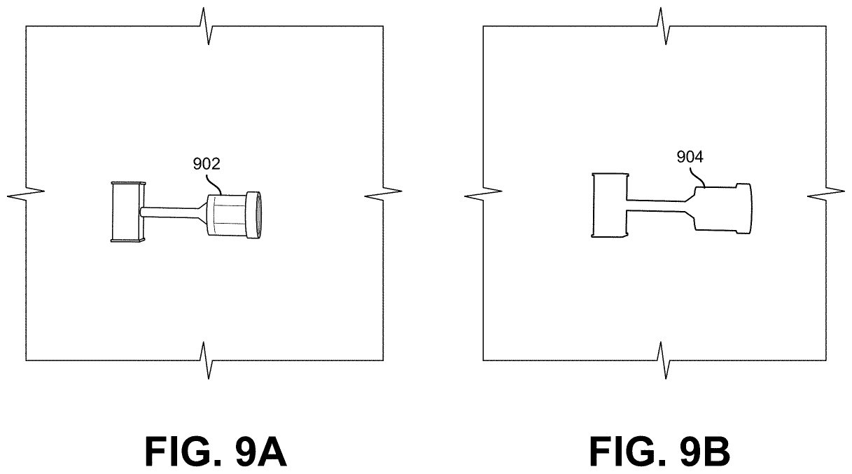

FIGS. 9A and 9B show an illustrative example of a simulated object under randomized illumination and a corresponding automatically-generated label for the object that can be used to identify the object, in an embodiment. FIG. 9A shows a simulated connector 902 under randomized illumination. FIG. 9B shows an automatically-generated label for the connector with the pixels 904 corresponding to the connector.

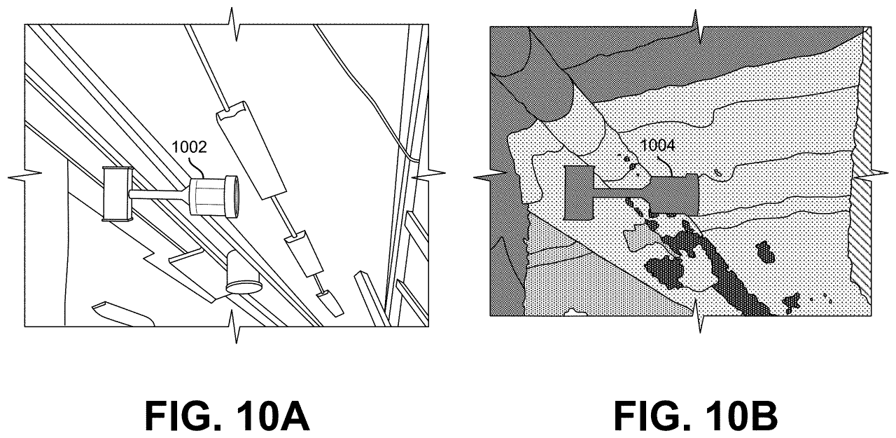

FIGS. 10A and 10B show an illustrative example of an object overlaid on a real-world background image and a simulated output of the object overlaid on a real-world image. FIG. 10A shows an example where a simulated connector 1002 overlaid on a real-world background image, and FIG. 10B shows an example of a simulated depth sensor output of the connector 1004 overlaid on a real-world depth image.

In some embodiments, simulated data is used to create hybrid images that contain both simulated and real-world data. The real-world data can come either from an existing image dataset or can be streamed in real-time while performing a task. As real-world data is received it is combined with data generated by the simulator, creating new training data with corresponding labels that can be used by a ML model. In this way, the model gains the advantages of both the efficiency and versatility of the simulation while lowering the reliance on the simulation's ability to perfectly simulate real-world conditions.

One such example involves overlaying simulated objects over images recorded in the real world. In one implementation, simulated images of a 3-D CAD object that has been spawned in various poses under various environmental conditions are recorded with a sensor such as a Kinect sensor. The simulation then outputs pixelwise labels of the image in a separate “annotation” image which represents different object classes as different colored labels. These classes correspond to classes in real-world data. Examples of classes include the object of interest that you want to detect and the background which you want to ignore. FIGS. 9A and 9B show an example of an image of a simulated object in a random pose and a pixel-wise label of that image. Using the masks of the simulated object, the pixels corresponding to that object can then be overlaid on an image recorded in the real-world. FIGS. 10A and 10B show an example of a simulated object overlaid on a real-world RGB and depth image. The resulting images can then be used to pre-train a ML model without requiring manual labelling of the object of interest.

Using a hybrid of simulated objects and real-world images has a few advantages over using pure simulated data and pure real-world data. For instance, it removes reliance on generating realistic backgrounds for an object of interest in the simulated world. The backgrounds in the resulting images are real-world backgrounds that are more similar to the environments that will be experienced by the ML model when performing a real-world task. The model therefore learns to differentiate directly between the object of interest and the background of a real-world environment, minimizing the dependency of training on a large variety of backgrounds to be able to generalize to the current environment. This hybrid also retains the advantage of high efficiency and automatic labelling as the same mask that was used to transfer the object to the real image and can be used as a label for training the ML model to detect that object. Furthermore, you still gain the advantages of controlling the simulated environment, such as generating instances of the object of interest in various orientations under different illuminations with sensor error.

There are many other ways in which hybrid data from simulations and real-world data can be used to train a ML model. For example, a colored 3-D model can be generated of an environment using methods such as SLAM. This model can take the form of textured 3-D point clouds or voxel maps which can be converted into a CAD model. This model can then be spawned in the simulator which can visualize it under various lighting conditions and in different poses. This can include objects of interest, such as a connector, and regions that were falsely detected by the ML model as belonging to the object of interest. A similar, but simpler system could take colors commonly seen in the current environment and use them to color randomly-generated objects in the simulation so that the simulated data contains colors that are present in the real-world scene. Both of these examples take information from a real-world environment and use it to generate more realistic simulated data in order to improve the performance of a ML model trained on that data. Such a system can be implemented in real-time, combining simulated data with real-world data as it is streamed from a sensor.

Another example of a real-time, hybrid system involves iteratively retraining or fine-tuning the ML model during a real-world task as the environment evolves. For example, if the lighting changes drastically, new objects appear in the scene or the sensor starts having higher amounts of noise, the simulator can generate new hybrid data using the data being streamed from the sensors. Then, the ML model can be retrained or fine-tuned with this new data on the fly. In this way, the model dynamically adapts to its current environment and has improved performance in a changing environment compared to a static ML model. This dynamic retraining can occur autonomously as computer vision technology can be used to automatically detect changes in illumination or, more simply, changes in average RGB intensities in the image, triggering retraining of the model with new hybrid data. Other cues, such as the command from a pilot to turn on a new light, can also be used to trigger generation of new hybrid data and retraining of the ML model. This lessens the responsibility of a pilot or operator by eliminating the need to manually choose to generate new hybrid training data and retrain the ML model.

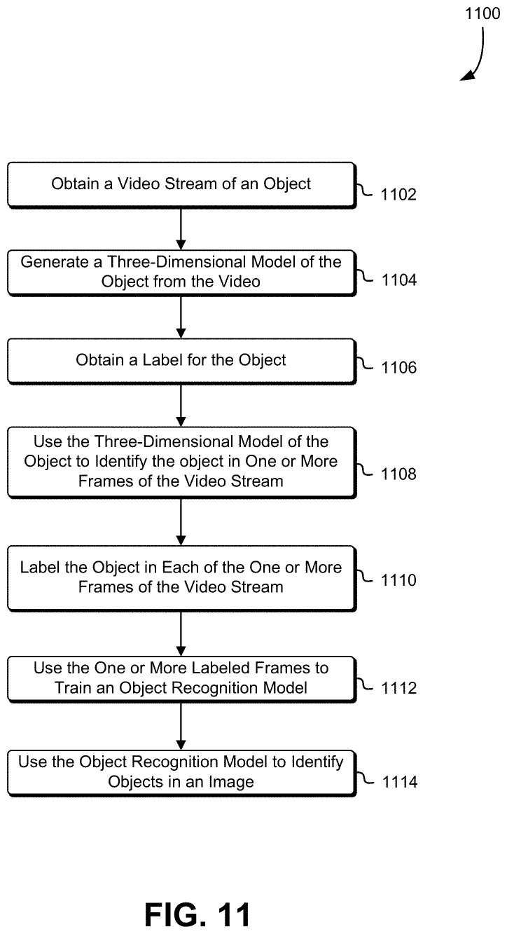

FIG. 11 illustrates an example of a process 1100 that, as a result of being performed by a computer system, trains a machine learning system to perform object recognition, in an embodiment. The process begins at block 1102 with a computer system obtaining a video stream of an environment that includes an object. The video stream can be acquired by a video camera, radar imaging device, LIDAR imager, ultrasonic imaging device, or infrared video camera. The video stream captures the environment from a variety of angles. In various embodiments, a variety of angles may be achieved by moving the camera or by moving individual objects within the environment. At block 1104, the computer system generates a three-dimensional model of the object from the video stream. The three-dimensional object can be a solid object model, a point cloud, a set of meshes, or a shell/boundary model. In one implementation, a SLAM system is used to generate the three-dimensional model.

In some examples, a LIDAR imager captures a three dimensional image of the environment. An object is identified and labeled in the three dimensional image as described above. In some examples, using the single LIDAR image and the labeled object in the image, a plurality of 2-dimensional images may be created, where each 2-dimensional image includes a labeled representation of the object.

In an embodiment, at block 1106, the system obtains a label for the object. The label can be obtained automatically through an object recognition system, or interactively by presenting an image of the object model to an operator, and having the operator select the object and enter and associated tag using a video display terminal having a keyboard and mouse.

At block 1108, the system uses the three-dimensional model of the object to identify the object in individual frames of the video stream. In one embodiment, the SLAM system generates an object mask for each frame of video used to generate the model, and the mask associated with each frame is used to identify the object. In another implementation, the system uses the model by positioning the model with an orientation that matches that of a frame on the video stream, and uses the position of the labeled object in the model to identify the area in the frame that corresponds to the object. In some embodiments, performance of the algorithm to generate the model involves determining pixels, regions, or other information that correspond to the object being modeled and, as a result, this information is used to label locations in individual images used to generate the model with a label of the object. For example, if a pixel of an image was used to generate a point on the model because that pixel was determined to be part of the object being modeled, that pixel (or an area comprising that pixel) is given the label of the object. After the object has been identified in each frame of the video stream, the system applies 1110 the label to the object in each frame of the video stream thereby producing a set of image frames each of which contains a labeled instance of the object.

In some examples, additional labeled images can be generated by combining a rendering of the three-dimensional object with another image such as a background image, a stock photo, or another video stream. The object can be rendered in a variety of poses and under a variety of lighting conditions to produce even more labeled training images. In another example, the object can be rendered as part of a simulation and images created from the simulation to produce additional labeled training images.

At block 1112, the computer system uses the labeled images as training data to train an object recognition model. In some implementations, the labeled image frames are provided to a machine learning system that implements an image recognition system. After completing the training process, the image recognition system is able to recognize objects similar to the labeled object in the training data. For example, in various examples, a new image containing a similar object is provided to the machine learning system, and the machine learning system recognizes 1114 that the similar object matches the object in the training data.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

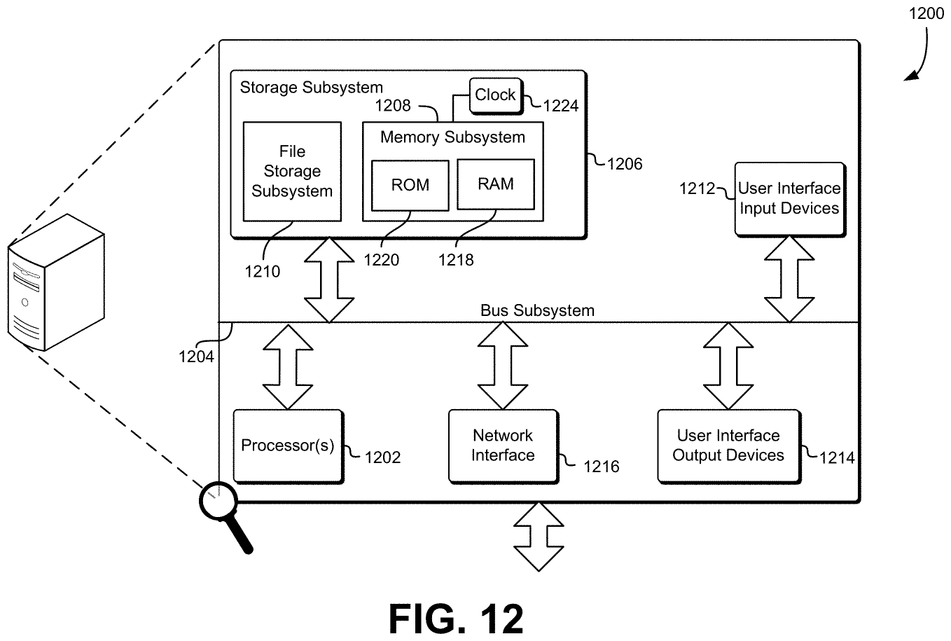

FIG. 12 is an illustrative, simplified block diagram of a computing device 1200 that can be used to practice at least one embodiment of the present disclosure. In various embodiments, the computing device 1200 may be used to implement any of the systems illustrated and described above. For example, the computing device 1200 may be configured for use as a data server, a web server, a portable computing device, a personal computer, tablet computer system, or any electronic computing device. As shown in FIG. 12, the computing device 1200 may include one or more processors 1202 that, in embodiments, communicate with and are operatively coupled to a number of peripheral subsystems via a bus subsystem. In some embodiments, these peripheral subsystems include a storage subsystem 1206, comprising a memory subsystem 1208 and a file/disk storage subsystem 1210, one or more user interface input devices 1212, one or more user interface output devices 1214, and a network interface subsystem 1216. The storage subsystem 1206 may be used for temporary or long-term storage of information. The processors may execute computer-executable instructions (which may be stored on a non-transitory computer-readable storage medium) to cause the computing device to perform operations to implement techniques described herein.

In some embodiments, the bus subsystem 1204 may provide a mechanism for enabling the various components and subsystems of computing device 1200 to communicate with each other as intended. Although the bus subsystem 1204 is shown schematically as a single bus, alternative embodiments of the bus subsystem utilize multiple buses. The network interface subsystem 1216 may provide an interface to other computing devices and networks. The network interface subsystem 1216 may serve as an interface for receiving data from and transmitting data to other systems from the computing device 1200. In some embodiments, the bus subsystem 1204 is utilized for communicating data such training data, data representing machine learning models, and other data involved in the implementation of the techniques described herein.

In some embodiments, the user interface input devices 1212 includes one or more user input devices such as a keyboard; pointing devices such as an integrated mouse, trackball, touchpad, or graphics tablet; a scanner; a barcode scanner; a touch screen incorporated into the display; joystick or other such device, mouse, trackpad, touchscreen, audio input devices such as voice recognition systems, microphones; and other types of input devices. In general, use of the term “input device” is intended to include all possible types of devices and mechanisms for inputting information to the computing device 1200. In some embodiments, the one or more user interface output devices 1214 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 1200. The one or more user interface output devices 1214 can be used, for example, to present user interfaces to facilitate user interaction with applications performing processes described and variations therein, when such interaction may be appropriate. For example, input devices may be used to enable users to provide feedback when utilizing techniques described herein involving at least some supervised learning. Output devices may enable users to view results of employment of techniques described herein.

In some embodiments, the storage subsystem 1206 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 1206. These application modules or instructions can be executed by the one or more processors 1202. In various embodiments, the storage subsystem 1206 additionally provides a repository for storing data used in accordance with the present disclosure. In some embodiments, the storage subsystem 1206 comprises a memory subsystem 1208 and a file/disk storage subsystem 1210.

In embodiments, the memory subsystem 1208 includes a number of memories, such as a main random access memory (RAM) 1218 for storage of instructions and data during program execution and/or a read only memory (ROM) 1220, in which fixed instructions can be stored. In some embodiments, the file/disk storage subsystem 1210 provides a non-transitory persistent (non-volatile) storage for program and data files and can include a hard disk drive, a solid-state storage device, a floppy disk drive along with associated removable media, a Compact Disk Read Only Memory (CD-ROM) drive, an optical drive, removable media cartridges, or other like storage media. Such a storage device may be used to store machine learning models, training data, results of application of trained models, and other related data, including computer-executable instructions that are executable by one or more processors to perform algorithms to implement techniques described herein and variations thereof.

In some embodiments, the computing device 1200 includes at least one local clock 1224. The at least one local clock 1224, in some embodiments, is a counter that represents the number of ticks that have transpired from a particular starting date and, in some embodiments, is located integrally within the computing device 1200. In various embodiments, the at least one local clock 1224 is used to synchronize data transfers in the processors for the computing device 1200 and the subsystems included therein at specific clock pulses and can be used to coordinate synchronous operations between the computing device 1200 and other systems, such as those which may be in a data center. In another embodiment, the local clock is a programmable interval timer.

The computing device 1200 could be of any of a variety of types, including a portable computer device, tablet computer, a workstation, or any other device described below. Additionally, the computing device 1200 can include another device that, in some embodiments, can be connected to the computing device 1200 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 1200 for processing. Due to the ever-changing nature of computers and networks, the description of the computing device 1200 depicted in FIG. 12 is intended only as a specific example for purposes of illustrating the preferred embodiment of the device. Many other configurations having more or fewer components than the system depicted in FIG. 12 are possible.

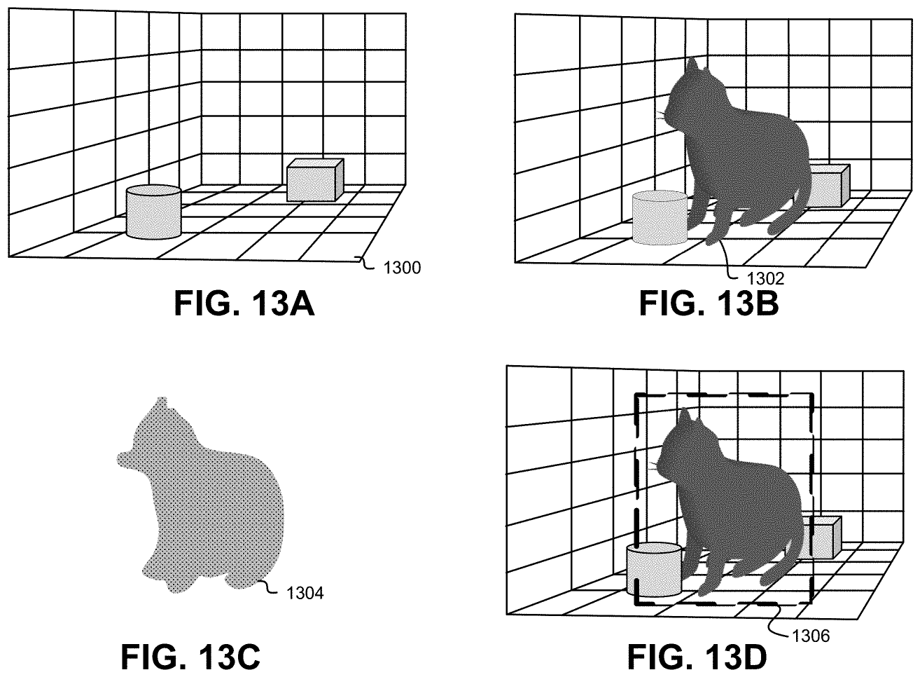

FIG. 13A shows an illustrative example of an environmental model used to identify a 3D model, in an embodiment. FIG. 13A illustrates an environmental model 1300 obtained from a sensor. For example, the environmental model 1300 can illustrate a simultaneous localization and mapping (“SLAM”) where range data from an Asus Xtion sensor is used to build a 3D model environmental model of a box and equipment in a laboratory. The environmental model 1300 can be represented from a set of one or more images. In an example, a sensor can obtain single images of a volume of an environment, such as a rectangular volume, and can include equipment, wherein individual images are indicative of different angle perspectives of the box and equipment. In various embodiments, textures are added and a stereo camera is used. In an example illustrated in FIG. 13A, an image is processed by the SLAM system to produce a 3D model of the environmental model 1300.

FIG. 13B shows an illustrative example of an environmental model including a 3D model indicative of an object introduced into the environmental model that is to be identified, in an embodiment. FIG. 13B illustrates a 3D model of an object 1302 obtained from a sensor as introduced into the environmental model 1300. The 3D model of the object 1302 can be represented from a set of one or more images. In an example, a sensor can obtain single images of an object introduced into the environment of a box and equipment, wherein individual images are indicative of different angle perspectives of the box and equipment. In various embodiments, textures are added and a stereo camera is used. In an example illustrated in FIG. 13B, an image is processed by the SLAM system to produce a 3D model of the object 1302 introduced into the environmental model 1300. It will be appreciated by one skilled in the art that multiple objects can be introduced into an environment, such that multiple 3D models of the objects are representative of corresponding multiple introduced elements into an environmental model 1300.

FIG. 13C shows an illustrative example of a difference between an environmental model with and without the 3D model indicative of an object introduced into an environmental model that is to be identified, in an embodiment. FIG. 13C illustrates a difference 1304 between the 3D model of the object 1302 obtained from a sensor as introduced into the environmental model 1300. A difference can be a calculated difference indicative of the environmental model 1300 without the presence of the 3D model of the object 1302 and with the presence of the 3D model of the object 1302.

In an embodiment, one or more filters can be utilized to calculate a difference between a first set of one or more images of the environmental model 1300 without the presence of the 3D model of the object 1302 and a second set of one or more images with the presence of the 3D model of the object 1302. For example, when processing in two dimensions the difference 1304 can be representative of a difference matte obtained by comparing a source layer—such as the first set of one or more—with a difference layer—such as the second set of one or more images—and then keying out pixels in the source layer that match both the position and color in the difference layer. When processing in three dimensions, the difference 1304 between two 3D point clouds can be processed with nearest neighbors of points captured in a video stream of an environment with the object, such as shown in an image of FIG. 13B, compared to any point in a video stream of an environment with the object, such as shown in FIG. 13A, to result in large distances for points corresponding to the 3D model of the object 1302. For example, when an introduced object into an environmental model is detected, the introduced object can be represented by a point cloud where the points are recorded for each frame of a video stream that the point cloud is generated from, and the recorded points indicative of the introduced object can be used to label which pixels in the corresponding frames are the introduced object. It will be appreciated that the point cloud of the difference 1304 is shown as a contiguous model corresponding to an individual introduced object 1302, and that noncontiguous and/or multiple point clouds can represent the difference corresponding to multiple introduced objects into the environmental model 1300.

In an embodiment, a pixel-by-pixel diff is produced by calculating a difference in pixel values between a first image—such as of an environment—and a second image—such as of an object in the environment. A pixel-by-pixel diff can be applied when the first and second images are obtained from the same relative position (relative to one another) to an imaging device or after one of the images is transformed, warped, and/or aligned to mimic the same relative position to an imaging device.

Additionally, a filter can be used to stabilize, color-correct, de-noise, or otherwise align similar perspective views of the environmental model 1300 between the first set and second set of images, based at least in part on the environmental model 1300 remaining substantially constant in the first and second set of images. In an embodiment, a difference determined between a first set of images of the environmental model 1300 without the presence of the 3D model of the object 1302 and a second set of images of the environmental model 1300 with the presence of the 3D model of the object 1302 can be used to obtain a point cloud for generating the 3D model of the object 1302, such as resulting from distinguishing points of the 3D model of the object 1302 and points that are not of the 3D model of the object 1302.

FIG. 13D shows an illustrative example of a 3D model indicative of an introduced object identified in an environmental model, in an embodiment. FIG. 13D illustrates a bounding box 1306 surrounding the 3D model of the object 1302 in the environmental model 1300. For example, the bounding box 1306 is generated from a bounding algorithm that indicates the range of pixels indicative of the 3D model of the object 1302. A bounding algorithm can identify the minimum and maximum points along dimensional axes (e.g., (Xmin, Ymin, Zmin), (Xmin, Ymin, Zmax), (Xmin, Ymax, Zmin), (Xmin, Ymax, Zmax), (Xmax, Ymin, Zmin), (Xmax, Ymin, Zmax), (Xmax, Ymax, Zmin), (Xmax, Ymax, Zmax)) of the cat object and use those points as vertices of a rectangular volume surrounding the cat object. It will be appreciated by one skilled in the art that a bounding algorithm can implement various techniques such that the resulting bounded area is not a rectangular volume, but can have a different number of faces and vertices, and does not necessarily have any symmetries.

In an embodiment, the bounding box 1306 is presented as a two dimensional rectangle around an image, such as when the bounding box 1306 drawn around the cat object is presented to a user. For example, a 3D viewer computer application displays a 3D rectangular box for an operator to view, where the operator can rotate and position the rectangular box so as to view the 3D model of the object 1302 from various perspectives. A bounding algorithm can apply a buffer value such that a resulting bounding box 1306 is larger than the 3D model of the object 1302. For example, the value of minimum points may be reduced and the value of maximum points may be increased.

In an embodiment, an application can present a user with a notification that the 3D model of the object 1302 was identified and request a confirmation from the user that the bounding box surrounds the entirety of the object 1302. For example, a bounding box may not surround the entirety of a cat object, such as excluding an ear, paw, or tail of the cat. The application request can prompt the user to indicate a portion of the object excluded from the bounding box and adjust the size of the bounding box to include the excluded portion of the object.

An application can prompt a user, such as by a dialog box, to label the 3D model of the object 1302 contained within the bounding box 1306. For example, a user can label the 3D model of the object 1302 as “cat.” In an embodiment, the label assigned by the user can be applied to a sequence of images containing the 3D model of the object 1302. In this manner, an application can label a plurality of images detected to contain the 3D model of the object 1302 based on a single labeled image, thereby propagating the label to the 3D model of the object 1302 for a plurality of images regardless of where the image used to apply the bounding box 1306 occurred within a sequence of the plurality of images.

In an embodiment where an application identified multiple objects, a bounding box is generated for individual objects. The application can prompt a user to label each individual object. The application can determine that two or more objects are similar, such as based on relative size, shape, color, reflectivity, etc., and prompt a user to validate whether a singular label can apply to the determined similar objects.

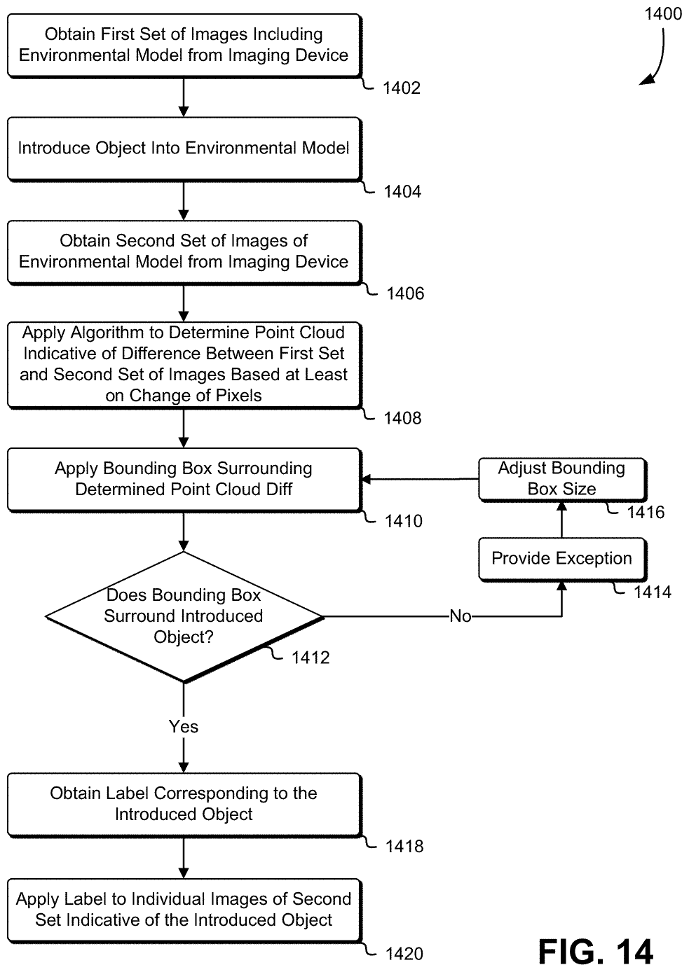

FIG. 14 illustrates an example of a process 1400 that, as a result of being performed by a computer system, calculates a difference between a first set of images of an environmental model without an object and a second set of images the environmental model including an object, the difference indicative of the object to be identified by a label, in an embodiment. The process begins at block 1402 with a computer system obtaining a first set of images of an environment, which can be used to derive an environmental model. The first set of images can be video stream. The first set of images can be acquired by a video camera, radar imaging device, LIDAR imager, ultrasonic imaging device, or infrared video camera as discussed herein. The first set of images captures the environment from a variety of angles, representative of at least the imaging sensor being in various orientations and providing various perspectives of the environment. In various embodiments, a variety of angles may be achieved by moving the camera or by moving individual objects within the environment.

At block 1404, an object is introduced into the environment. The computer system can detect, identify, or receive an alert that the object was introduced. At block 1406, the computer system obtains a second set of images from an imaging device of the environment including the introduced object. The second set of images can be acquired and in a format similar to the first set of images as described above. In an embodiment, a label is included with the obtained second set of images corresponding to the introduced object. The object can be represented as a point cloud, where the computer system stores data indicating which frame(s) each pixel of the point cloud originated from, which, in an embodiment, is data obtained during performance of the algorithm to generate the point cloud. The stored data can also include metadata about the imaging device that obtained the second set of images, such as the orientation and/or position of the imaging device relative to the environment.

At block 1408, the computer system applies an algorithm to determine a point cloud indicative of a difference between the first set of images and the second set of images. In one embodiment, the computer performs image processing, such as image differencing, to derive a comparison between the first set of image and the second set of images. In performing image processing, the computer system can also apply a filter in determining the difference between the first set of images and second set of images. For example, a filtered diff function can compare the environment represented in the first set of images with the environment and introduced object represented in the second set of images. Where each point cloud indicative of the difference contains noise or variations in point placement, filtering can minimize extraneous points. For example, one method of filtering includes determining a coarse 3D histogram of each data set and comparing the histogram voxels for point count, wherein any voxel with a difference above a small count threshold would be considered associated with the object introduced into the environment. One skilled in the art will appreciate there are many other variations of filtered diff algorithms to yield a difference between a first set of images and a second set of images.

The computer system can generate a 3D model of the object from a portion of the second set of images. The 3D model can be a solid object model, a point cloud, a set of meshes, or a shell/boundary model. In an embodiment, based on a video stream, the computer system can use structure from motion (SFM) to construct a 3D point-cloud for frame-pairs or collect 3D RGBD sensor data from a Kinect-like or LIDAR sensor. In one implementation, the computer system applies one or more Simultaneous Localization and Mapping (SLAM) algorithms to each image representing a 3D data set and registers each 3D set to others of the second image set including the introduced object. The computer system can also derive relative six degrees-of-freedom (“DOF”) transforms between images and create a unified 3D point cloud of the environment. At block 1410, the computer system applies a bounding box that substantially surrounds the determined point cloud difference.

At block 1412, the computer system issues a request for a response of whether the bounding box surrounds the entire object. For example, the computer system can present a dialog box to a human operator for the operator with options to confirm or deny that the bounding box surrounds the entire object, wherein a selection of confirm or deny transmits such indication as a response to the computer system. If the bounding box does not surround the entire object, at block 1414, the computer system issues an exception. The exception can include an indication from the human operator what size of the bounding box should be moved outwards, thereby increasing the area of the bounding box, to surround the entire object. Accordingly at block 1416, the computer system adjusts the size of the bounding box and returns the process to 1410 to apply the bounding box around the object. If the bounding box surrounds the entire object, then the process proceeds to block 1418.

At block 1418, the computer system obtains a label corresponding to the introduced object. In an embodiment, the computer system receives a notification from a human operator including a label. In one implementation, the received notification at block 1418 is a confirmation that a label obtained with the second set of images at block 1406 is accurate.

At block 1420, the computer system applies the obtained label to the image including the bounding box and images of the second set. The label can be applies to individual pixels of the second set of images (either by individual pixels or by labeling a bounding shape that contains the individual pixels) in each frame. For example, the computer system can apply the label to all images registered as including the object. In an embodiment, the computer system identifies all points corresponding to the 3D model within the environment, and using the transforms of SLAM processing, maps those points back on to the individual images. For example, the mapping can apply to 2D images for SFM or RGBD images for Kinect or LIDAR data to create a labeled set of images. In one implementation, points within voxels indicated by the filtered diff are used to re-project those points to their source images and apply the label to each of the second set of images including the introduced object. The images as labeled can be used to train an image classification machine learning model. For example, a cat object as labeled resulting from FIG. 13D can be used to train an image classification machine learning model to identify cats.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the scope of the invention, as defined in the appended claims.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs, or one or more applications) executing collectively on one or more processors, by hardware, or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

Additionally, embodiments of the present disclosure can be described in view of the following clauses:

1. A computer-implemented method, comprising: obtaining video data of a three-dimensional object, the video data comprising a plurality of two-dimensional frames each capturing the three-dimensional object from a different perspective; generating, based on the video data, a three-dimensional model of the object; obtaining a label for the three-dimensional object; using the three-dimensional model of the object to identify the three-dimensional object in each frame of a subset of the plurality of two-dimensional frames; generate a data set that associates the label with the three-dimensional object in each frame of the subset of frames; and use the data set to train a model to be used for object recognition.
2. The computer-implemented method of clause 1, further comprising: obtaining an image of an additional three-dimensional object; and determine a location of the additional three-dimensional object using the three-dimensional model of the object and the model used for object recognition.
3. The computer-implemented method of clause 1 or 2, wherein the video data is generated with an infrared image sensor, a radar sensor, or a LIDAR sensor.
4. The computer-implemented method of any of clauses 1 to 3, further comprising: Presenting a representation of a three dimensional environment on an interactive video display terminal; obtaining, via the interactive video display terminal, information that identifies the three-dimensional object; and obtaining a label associated with the three-dimensional object via the interactive video display terminal.
5. A system, comprising: one or more processors; and memory storing executable instructions that, as a result of being executed by the one or more processors, cause the system to: use a model generating algorithm to determine portions of instances of content that correspond to an object represented in the content; obtain a data set that associates the portions of the instances of content with a label; and use the data set to train a model.
6. The system of clause 5, wherein the data set is obtained by at least: obtaining an object label for the object; identifying the object in the portions of the instances of content; and associating the object label with the portions of the instances of content.
7. The system of clause 6, wherein: the object is displayed on an interactive display terminal; the object is identified by a user using an interactive display terminal; and the object label is obtained from the user.
8. The system of any of clauses 5 to 7, wherein the executable instructions, as a result of being executed by the one or more processors, further cause the system to: generate a three-dimensional model that represents the object; and identify the portions of the instances of content the object using the three-dimensional model.
9. The system of any of clauses 5 to 8, wherein: the instances of content are images; and the images are generated in part by adding a rendering of the object to each image in a set of background images.
10. The system of clause 9, wherein each image of the images includes a rendering of the object where the object has a different orientation.
11. The system of any of clauses 5 to 10, wherein: the data set is provided to a machine learning system; and the model is a machine learning model that configures the machine learning system to identify the object in additional instances of content.
12. The system of clause 11, wherein: the instances of content are frames of a first video stream; and the additional instances of content are frames of a second video stream.
13. A non-transitory computer-readable storage medium having stored thereon executable instructions that, as a result of being executed by one or more processors of a computer system, cause the computer system to at least: use a model generating algorithm to determine portions of instances of content that correspond to an object represented in the content; obtain a data set that associates the portions of the instances of content with a label; and provide the data set to be used to train a model.
14. The non-transitory computer-readable storage medium of clause 13, wherein the executable instructions further comprise instructions that, as a result of being executed by the one or more processors, cause the computer system to: generate a mathematical three-dimensional model of the object; add a rendering of the mathematical three-dimensional model to a real-world image to produce a labeled training image; and add the labeled training image to the data set.
15. The non-transitory computer-readable storage medium of clause 13 or 14, wherein the executable instructions further comprise instructions that, as a result of being executed by the one or more processors, cause the computer system to: generate a plurality of renderings of the mathematical three-dimensional model in a variety of different orientations; add the plurality of renderings to one or more images to produce a plurality of training images; and add the plurality of training images to the data set.
16. The non-transitory computer-readable storage medium of clause 14, wherein the executable instructions further comprise instructions that, as a result of being executed by the one or more processors, cause the computer system to: generate a plurality of renderings of the mathematical three-dimensional model using a variety of different illumination conditions; add the plurality of renderings to one or more images to produce a plurality of training images; and add the plurality of training images to the data set.
17. The non-transitory computer-readable storage medium of any of clauses 13 to 16, wherein the executable instructions further comprise instructions that, as a result of being executed by the one or more processors, cause the computer system to use the model to estimate the position and orientation of the object.
18. The non-transitory computer-readable storage medium of any of clauses 13 to 17, wherein the executable instructions further comprise instructions that, as a result of being executed by the one or more processors, cause the computer system to: generate a simulated environment; add the object to the simulated environment; and generate the instances of content from the simulated environment.
19. The non-transitory computer-readable storage medium of any of clauses 13 to 18, wherein the instances of content are video frames.
20. The non-transitory computer-readable storage medium of any of clauses 13 to 19, wherein the model generating algorithm is a simultaneous localization and mapping algorithm.

What is claimed is:

1. A computer-implemented method, comprising:
obtaining video data of a three-dimensional object, the video data comprising a plurality of two-dimensional frames each capturing the three-dimensional object from a different perspective;
generating, based on the video data, a three-dimensional model of the object;
obtaining a label for the three-dimensional object;
using the three-dimensional model of the object to identify the three-dimensional object in each frame of a subset of the plurality of two-dimensional frames;
generating a data set that associates the label with the three-dimensional object in each frame of the subset of frames; and
using the data set to train a model to be used for object recognition.

2. The computer-implemented method of claim 1, further comprising:
obtaining an image of an additional three-dimensional object; and
determining a location of the additional three-dimensional object using the three-dimensional model of the object and the model used for object recognition.

3. The computer-implemented method of claim 1, wherein the video data is generated with an infrared image sensor, a radar sensor, or a LIDAR sensor.

4. The computer-implemented method of claim 1, further comprising:
displaying a representation of a three-dimensional environment on an interactive video display terminal;
obtaining, via the interactive video display terminal, information that identifies the three-dimensional object; and
obtaining a label associated with the three-dimensional object via the interactive video display terminal.

5. A system, comprising:
one or more processors; and
memory storing executable instructions that, as a result of being executed by the one or more processors, cause the system to:
use a model generating algorithm to determine portions of instances of content that correspond to an object represented in the content;
obtain a data set that associates the portions of the instances of content with a label; and
use the data set to train a model.

6. The system of claim 5, wherein the data set is obtained by at least:
obtaining an object label for the object;
identifying the object in the portions of the instances of content; and
associating the object label with the portions of the instances of content.

7. The system of claim 6, wherein:
the object is displayed on an interactive display terminal;
the object is identified by a user using an interactive display terminal; and
the object label is obtained from the user.

8. The system of claim 5, wherein the executable instructions, as a result of being executed by the one or more processors, further cause the system to:
generate a three dimensional model that represents the object; and
identify the portions of the instances of content the object using the three-dimensional model.

9. The system of claim 5, wherein:
the instances of content are images; and
the images are generated in part by adding a rendering of the object to each image in a set of background images.

10. The system of claim 9, wherein each image of the images includes a rendering of the object where the object has a different orientation.

11. The system of claim 5, wherein:
the data set is provided to a machine learning system; and
the model is a machine learning model that configures the machine learning system to identify the object in additional instances of content.

12. The system of claim 11, wherein:
the instances of content are frames of a first video stream; and
the additional instances of content are frames of a second video stream.

13. A non-transitory computer-readable storage medium having stored thereon executable instructions that, as a result of being executed by one or more processors of a computer system, cause the computer system to at least:
use a model generating algorithm to determine portions of instances of content that correspond to an object represented in the content;
obtain a data set that associates the portions of the instances of content with a label; and
provide the data set to be used to train a model.

14. The non-transitory computer-readable storage medium of claim 13, wherein the executable instructions further comprise instructions that, as a result of being executed by the one or more processors, cause the computer system to:
generate a mathematical three dimensional model of the object;
add a rendering of the mathematical three-dimensional model to a real-world image to produce a labeled training image; and
add the labeled training image to the data set.

15. The non-transitory computer-readable storage medium of claim 14, wherein the executable instructions further comprise instructions that, as a result of being executed by the one or more processors, cause the computer system to:
generate a plurality of renderings of the mathematical three-dimensional model in a variety of different orientations;
add the plurality of renderings to one or more images to produce a plurality of training images; and
add the plurality of training images to the data set.

16. The non-transitory computer-readable storage medium of claim 14, wherein the executable instructions further comprise instructions that, as a result of being executed by the one or more processors, cause the computer system to:
generate a plurality of renderings of the mathematical three-dimensional model using a variety of different illumination conditions;
add the plurality of renderings to one or more images to produce a plurality of training images; and
add the plurality of training images to the data set.

17. The non-transitory computer-readable storage medium of claim 13, wherein the executable instructions further comprise instructions that, as a result of being executed by the one or more processors, cause the computer system to use the model to estimate the position and orientation of the object.

18. The non-transitory computer-readable storage medium of claim 13, wherein the executable instructions further comprise instructions that, as a result of being executed by the one or more processors, cause the computer system to:
generate a simulated environment;
add the object to the simulated environment; and
generate the instances of content from the simulated environment.

19. The non-transitory computer-readable storage medium of claim 13, wherein the instances of content are video frames.

20. The non-transitory computer-readable storage medium of claim 13, wherein the model generating algorithm is a simultaneous localization and mapping algorithm.
